(19) United States
(12) Patent Application Publication
(10) Pub. No.: US 2024/0311275 A1
(43) Pub. Date: Sep. 19, 2024

(54) AUTOMATIC IMPACT ASSESSMENT OF BUGS ON OPERATIONS AND CHANGE REQUESTS (CR)

(71) Applicant: Rakuten Mobile, Inc., Tokyo (JP)

(72) Inventor: Amit AGRAWAL, Tokyo (JP)

(21) Appl. No.: 18/245,345

(22) PCT Filed: Dec. 6, 2022
(86) PCT No.: PCT/US2022/052007

§ 371 Date: Mar. 15, 2023

(51) Int. Cl. G06F 11/36

(52) U.S. Cl. CPC G06F 11/3624

(57) ABSTRACT

An automatic impact assessment on operations and change requests (CR) caused by bugs of open-source software (OSS) is described. A bug repository is created for storing information about bugs of OSS. A method of procedures (MOP) repository for storing procedures for addressing the bugs of the OSS is created. The procedures in the MOP repository for addressing the bugs and information about the bugs in the bug repository are analyzed to identify at least one bug resulting in an impact on the operation of the OSS. A MOP Risk Assessment Dashboard is provided for analyzing the procedures in the MOP repository and bugs information in the bug repository. The analysis is performed manually from the MOP Risk Assessment Dashboard, or are analyzed automatically using artificial intelligence. At least one bug is identified and displayed on the MOP Risk Assessment Dashboard.

### TECHNICAL FIELD

This description relates to automatic impact assessment of known bugs on operations and change requests (CR).

### BACKGROUND

Open-Source Software (OSS) has become a common tool for enterprise application development and delivery. Open source tools have been developed to help improve and troubleshoot issues, including GitHub, SourceForge, Launchpad, and others. For example, GitHub is an Internet hosting service for software development and version control using Git. GitHub provides the distributed version control of Git plus access control, bug tracking, software feature requests, task management, continuous integration, and wikis for projects.

The telecommunications industry is going through a transformation involving virtualization based on the use of cloud, native applications, e.g., Open RAN and commodity hardware utilization. The virtualization leverages OSS capabilities. However, the use of OSS relies on continuous assessment of open or known bugs of the OSS to operate properly. Problems that occur with software is referred to as bugs. A software bug is an error, flaw or fault in the design, development, or operation of computer software that causes it to produce an incorrect or unexpected result, or to behave in unintended ways. Because these are OSS, the community identifies bugs and reports the bug to the community. Thus, the impact of the known bugs on operations and change request executions is frequently assessed.

Currently, there is no mechanism available to make operations safe from such open/known problems of OSS. There is no tool in the telecommunications industry, e-commerce industry, or Internet industry that automatically connects the open bugs with ongoing operations. Thus, numerous incidents occur because of bugs of the OSS.

To address software bugs of OSS, operations teams focus on the validation of the Method Of Procedure (MOP) or operation manuals and laboratory testing before executing OSS in a live network. A MOP details steps to implement to test the that the OSS functions as expected. Lab validation is used to generate MOP documents for operational and deployment procedures. Verification of software in the lab decreases risk of operational errors and helps detect software bugs in order to avoid crashing software in the production network

### SUMMARY

In at least embodiment, a method for performing automatic impact assessment on operations and change requests (CR) caused by bugs of Open-Source Software (OSS) includes creating a bug repository for storing information about bugs of OSS, creating a method of procedures (MOP) repository for storing procedures for addressing the bugs of the OSS, analyzing the procedures in the MOP repository for addressing the bugs and information about the bugs of the bug repository to identify at least one bug resulting in an impact on the operation of the OSS, and presenting, on a display, the at least one bug resulting in the impact on the operation of the OSS.

In at least one embodiment, a system for performing automatic impact assessment of bugs of Open-Source Software (OSS) includes a memory storing computer-readable instructions, and a processor connected to the memory, wherein the processor is configured to execute the computer-readable instructions to create a bug repository storing information about bugs of OSS, create a method of procedures (MOP) repository for storing procedures for addressing the bugs of the OSS, analyze the procedures in the MOP repository for addressing the bugs and information about the bugs in the bug repository to identify at least one bug resulting in an impact on operation of the OSS, and present, on a display, the at least one bug resulting in the impact on the operation of the OSS.

In at least one embodiment, a non-transitory computer-readable media having computer-readable instructions stored thereon, which when executed by a processor causes the processor to perform operations including creating a bug repository for storing information about bugs of OSS, creating a method of procedures (MOP) repository for storing procedures for addressing the bugs of the OSS, analyzing the procedures in the MOP repository for addressing the bugs and information about the bugs in the bug repository to identify at least one bug resulting in an impact on the operation of the OSS, and presenting, on a display, the at least one bug resulting in the impact on the operation of the OSS.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 is a diagram of implementation of Open-Source Software (OSS) according to at least one embodiment.

FIG. 2 is a system for providing automatic impact assessment of software bugs on operations and change requests (CR) according to at least one embodiment.

FIG. 3 is a diagram of a Method of Procedure (MOP) Repository according to at least one embodiment.

FIG. 4 is a diagram of a Bug Repository according to at least one embodiment.

FIG. 5 is a flowchart of a method for merging regions according to at least one embodiment.

FIG. 6 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or data-streams or signaling-streams. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, or data-streams or signaling-streams from UE.

In at least one embodiment, a method for performing automatic impact assessment on operations and change requests (CR) caused by bugs of Open-Source Software (OSS) includes creating a bug repository for storing information about bugs of OSS, creating a method of procedures (MOP) repository for storing procedures for addressing the bugs of the OSS, analyzing the procedures in the MOP repository for addressing the bugs and information about the bugs in the bug repository to identify at least one bug resulting in an impact on the operation of the OSS, and presenting, on a display, the at least one bug resulting in the impact on the operation of the OSS.

Embodiments described herein provide method that provides one or more advantages. For example, advantages include providing automatic impact assessment of known bugs on operation and change requests (CR). A change request is a proposal made in the software development process to change an aspect or coding in the OSS. An example of a change requests include requests to correct defects or bugs. A MOP Risk Assessment Dashboard using an AI/ML engine to perform a quick check of operation safety against known bugs based on information form a bug repository and a MOP repository. MOP Risk Assessment Dashboard performs real time impact assessment by matching bug IDs and MOP IDs to minimize the impact and down time. The impact assessment process is simplified and speeds the process of impact assessment of known bugs on operation and change requests (CR). The MOP Risk Assessment Dashboard uses the AI/ML engine to provide automatic impact assessment of known bugs on operation and change requests (CR), provide a higher operation success rate, reduce cost of verification and troubleshooting, and reduce employee stress during operations by making of operations safe, repeatable, and stress free. The user is able to quickly check the commands, if any, that are impacted due to the open or known bugs.

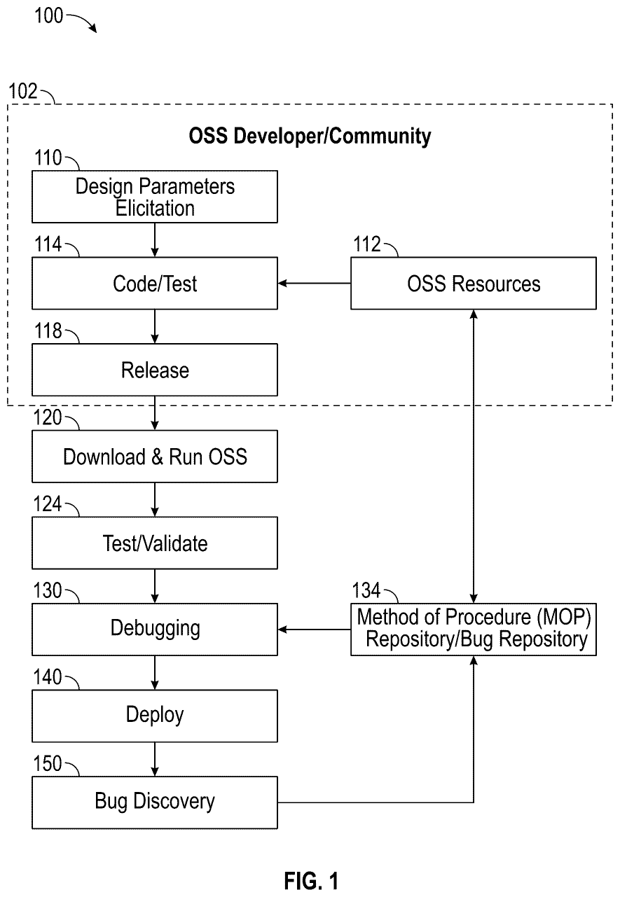

FIG. 1 is a diagram of implementation of Open-Source Software (OSS) 100 according to at least one embodiment.

FIG. 1 shows the overall process of OSS development/Community 102 and implementation by a user. In FIG. 1, the process activities performed by the OSS developers include design parameters elicitation 110, coding and testing 114, and release 118.

OSS is a broad term used to describe software that is developed and released under a form of “open source” license. There are many licenses with a range of different features, which allow inspection of the software's source code. Open-Source Software (OSS) development is characterized by collaborative and voluntary software development carried out by several developers distributed geographically.

Design Parameters Elicitation 110 involves a developer identifying features to include in OSS, reporting and working on new features, or fixing defects in OSS. The Design Parameters Elicitation 110 is accomplished by using several sources, such as developer mailing lists, project webpage, wiki roadmap or newsgroups, and bug reporting or tracking systems. The use of a wider audience in OSS development facilitates a greater influx of ideas and a greater degree of innovation.

Once the design parameters have been identified in the Design Parameters Elicitation 110 phase, Coding and Testing 114 of OSS begins. Developers navigate from the design parameters to realization in the code. Coding is able to be accomplished by writing new code, modifying and re-using many open source projects. Modification includes re-writing the code of existing products, with enhancements and alterations made where applicable.

Next, Coding and Testing 114 of OSS involves the testing of code. Testers examine software and applications at different stages. The OSS is evaluated, tested, and verified against the information obtained during the design parameters elicitation 110 and evaluation of the OSS for proper execution. The status of various issues in the development of the OSS is able to be tracked using a bug tracking system maintained by the organization responsible for development of the OSS.

After, the OSS completes the Coding and Testing 114, the OSS is Released 118. OSS projects tend to make a release available early to be used by the user community and then quickly update the releases as the OSS is modified. Releases are made frequently, so that the effectiveness of contributions are tested immediately. Feedback on the latest version is received and contributions again incorporated into the code in a continuous cycle, which continues until the community is satisfied with the eventual outcome.

A consumer Downloads and Runs OSS 120 in an environment of a consumer. Virtualization, Open RAN and commodity HW utilization in the telecommunications industry has opened the opportunity of utilizing OSS capabilities. To determine whether the OSS meet the goals of the consumer in using the OSS, OSS transitions to the Test and Validate 124 phase, where the OSS is tested and validated in the consumer's laboratory environment before using the OSS in a live environment.

Debugging 130 involves assessment of open/known bugs of the OSS software and is carried out to determine the impact of open/known bugs on operations and change request. During Debugging 130, execution of the OSS is monitored. Debugging 130 is the process of detecting and removing of existing and potential errors (also called as ‘bugs’) in a software code that can cause it to behave unexpectedly or crash.

To prevent incorrect operation of a software or system, Debugging 130 attempts to discover and resolve bugs or defects. Method of Procedures (MOP)/Bug Repository 134 are used to identify bugs of the OSS and validate the OSS in a laboratory environment before pushing the OSS to a live network. Bug Repository 134 is populated by a team that reviews information provided by OSS Resources 112. Thus, information about known or open bugs is downloaded to a bug repository of MOP/Bug Repository 134.

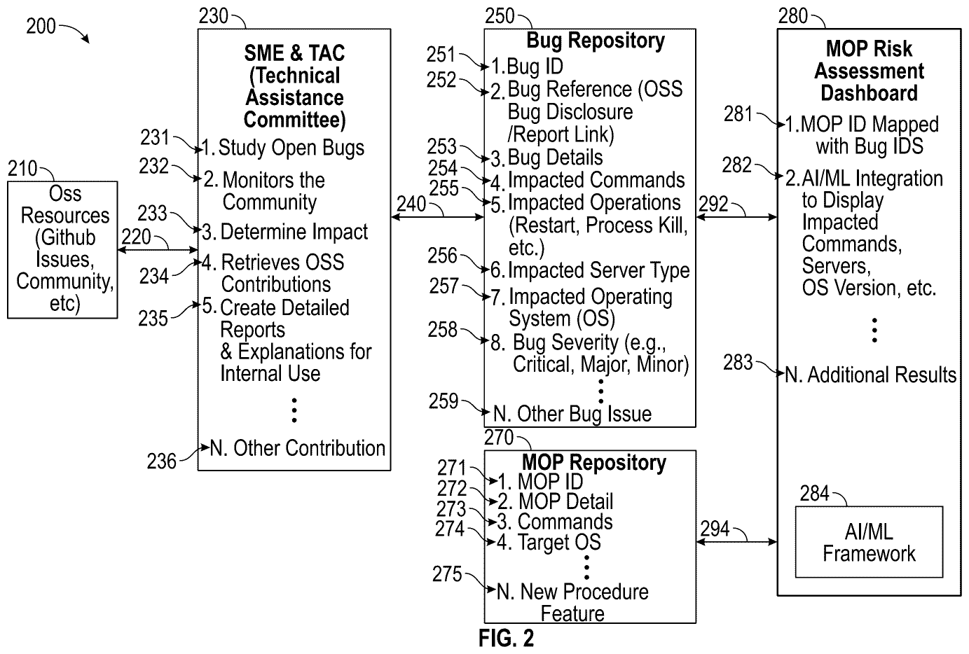

Once the OSS has passed the Debugging 130, the OSS is Deployed 140 in a live network. However, the OSS is frequently monitored during Bug Discovery 150 to identify the existence of additional bugs using MOP/Bug Repository 134. Bugs discovered in Bug Discovery 150 is able to be added to bug repository of MOP/Bug Repository 134, and the MOPS in MOP/Bug Repository 134 are updated. The new bug information is able to be provided back to OSS Resources 112, where the new bug information is available to developers at Code/Test 114 phase. Further details of a system for providing automatic impact assessment of known bugs on operations and change requests (CR) is described with reference to FIG. 2.

As mentioned, previous methods do not utilize a bug repository to identify bugs of OSS, but instead focus on laboratory, preproduction, or staging, intensive testing and method of procedure reviews. However, the previous methods are not efficient or sufficient to address the impact of known or open software bugs, and especially corner or sporadic bugs, on operations and change requests (CR). Previous methods do not provide automation and rely on a tremendous amount of research of open issues.

FIG. 2 is a system 200 for providing automatic impact assessment of software bugs on operations and change requests (CR) according to at least one embodiment.

In FIG. 2, system 200 shows an end to end visualization of the workflow for providing automatic impact assessment of known bugs on operations and change requests (CR) according to at least one embodiment. System 200 shows OSS Resources 210 where known or open bugs are identified by members of the OSS community and maintained. OSS Resources 210 include sources, such as GitHub Listed Issues, Community web pages, etc. Thus, the Open-Source Software (OSS) communities identify issues in OSS, and list the issues on the Internet.

A Team 230 monitors the OSS Resources 210 that are associated with OSS of interest. The Team 230 obtains information about bugs 220 from the OSS Resources 210. The Team 230 includes Subject Matter Experts (SME) and members of a Tactical Assistance Committee (TAC). A company does not use all of the different types of OSS. Thus, to obtain information about known or open bugs of OSS of interest, Team 230 studies the OSS resources 210 and identifies bugs that are capable of having an impact on operations or change requests (CR).

The SME and TAC Team 230 reviews the OSS resources 210 and studies open bugs 231, monitors community discussions related to performance, stability, security, and vulnerability of OSS 232, determines the impacts of identified bugs 233, retrieves OSS contributions to the identification of bugs 234, and creates a detailed report and explanation associated with the known/open bugs 235. The report 235 is accessible for internal use in determining the impact of known/open bugs.

Those skilled in the art recognize that examples 231-235 is provided as an example, and that additional or alternative information 236 is able to be obtained by the SME and TAC Team 230. SME and TAC Team 230 provides the obtained bug information 240 to Bug Repository 250.

Bug Repository 250 includes information associated with bugs, such as Bug Identifier (ID) 251, Bug Reference (OSS disclosure/report link) 252, Bug details 253, Impacted Commands 254, Impacted Operations 255 (restart, process kill etc.), Impacted Server Type 256, Impacted Operating System (OS) 257, and Bug Severity 258 (e.g., Critical, Major, Minor). Bug Repository 250 is also able to be supplemented to add New Issues 259.

With regard to Bug Repository 250, a master database is able to be used to maintain information on the different types of Open-Source Software. In at least one embodiment, an enable/disable or toggle button is able to be used to filter OSS and the bugs applicable to the OSS being used. The master database is able to be configured for applicability to an industry or applicable companies. In at least one embodiment, Bug Repository 250 is based upon the open issues which are known through different communities and the Open-Source Software websites, blogs, list servers, etc.

For example, an incident involving a command is identified that wipes out a cluster that includes a group of servers. In addition to wiping out the cluster, many sites are taken out, e.g., 300 sites. Impacted commands affect operations, e.g., restart process, scale and impacted server type. The servers that are brought down by such a command include any type of server, such as HP servers, IBM servers, etc. Depending upon the research that is performed by SME and TAC Team 230, Bug Repository 250 keeps evolving.

MOP Repository 270 is created by mitigation teams to provide precise step-by-step information for providing procedures for addressing open/known bugs of OSS to provide automatic impact assessment of the bugs on operations and change requests (CR) according to at least one embodiment. A change request is a proposal made in the software development process to change an aspect or coding in the OSS. An example of a change requests include requests to correct defects or bugs.

In at least one embodiment, the MOP Repository 270 is based on an operations manual. MOP Repository 270 provides a means to control the outcome of the automatic impact assessment and reduces problems that may arise from guesswork or human error. MOP Repository 270 is able to provide uniformity and accuracy while avoiding (or at least minimizing) mistakes.

MOP Repository 270 includes a MOP ID 271, MOP Details 272, a list of Commands 273, Target OS 274, etc. MOP Repository 270 is able to be supplemented to add New Procedure Features 275. For example, MOP Repository 270 is able to identify what type of server, OS version, etc. that is impacted by bugs. A validation of MOPS Repository 270 is performed and the details are listed in the MOP repository 270.

A MOP Risk Assessment Dashboard 280 is able to access Bug Repository 250 and MOP Repository 270. MOP Risk Assessment Dashboard 280 maps MOP IDs with Bug IDs 281. MOP Risk Assessment Dashboard 280 includes an Artificial Intelligence (AI)/Machine Learning (ML) Framework 284 and displays impacted commands, servers, OS version, and other information 282. Additional results 283 are also able to be provided.

In FIG. 2, MOP Risk Assessment Dashboard 280 is shown to include Artificial Intelligence (AI)/Machine Learning (ML) Framework 284. Artificial Intelligence (AI) is the capability of a computer system to mimic human cognitive functions such as learning and problem-solving. Through AI, a computer system uses math and logic to learn from new information and make decisions. Machine Learning (ML) is an application of AI. Machine Learning uses mathematical models of data so a computer learns without direct instruction. This enables a computer system to continue learning and improving on its own, based on experience. Machine learning is considered a subset of AI.

MOP Risk Assessment Dashboard 280 AI/ML Framework 284 receives information 292 from Bug Repository 250. AI/ML Framework 284 also receives information 294 from MOP Repository 270. Based on that selection or filtering of bugs, the AI/ML Framework 284 compares the bugs in Bug Repository 250 applicable to the OSS to MOPS in the MOPS Repository 270. As described above, a manual comparison is able to be used until the AI/ML Framework 284 has been trained. Thus, in at least one embodiment, System 200 is a universal tool for industries. In at least one other embodiment, System 200 is a tool applicable to the telecommunications industry.

Based upon a match being identified, Bug ID's 251 are listed against MOP IDS 271 that reflect risk. The risks are based upon Bug Severity 258. The AI/ML Framework 284 is based upon matching logic that improves over time. The Bug Repository 250 and MOP Repository 270 are connected as part of an integrated system.

Initially, before the AI/ML Framework 284 has been trained, tested, and validated, System 200 is not automated. However, Bug Repository 250 and MOP Repository 270 enable impact assessment based on manual comparisons. Thus, initially a manual confirmation of MOPs in MOP Repository 270 is performed. In at least one embodiment, a manual comparison involves performing a check of critical bugs in Bug Repository 250 against MOPs in MOP Repository 270.

For example, MOPs in MOP Repository 270 are identified that target the servers that are running on Kubernetes version X. Then, bugs from Bug Repository 250 are compared to bugs that are determined to be impacting Kubernetes version X. A manual comparison is able to be performed in 10-15 minutes. Accordingly, Bug Repository 250 and MOP Repository 270 are used to provide an impact assessment that enables secure operations after a manual check. Once the AI/ML Framework 284 is able to take over, the AI/ML Framework 284 provides automatic impact assessment of known bugs on operations and change requests (CR).

Kubernetes is one example, of a commonly used Open-Source Software (OSS) that is used in many industries. Companies today are moving to commodity hardware and containerized OSS. A bug in Kubernetes is identified as having an impact on a cluster. For example, the cluster includes one or more master server/nodes and many worker servers/nodes. Two or three master servers are able to be used with one of the master servers being an active master server and the other servers being a primary backup master server and one or more secondary master backup servers. The remaining servers are worker servers. The identified bug is determined to be involved in executing a command on a standby master server.

The standby master servers are used in response to the active master server experiencing some problem or issue. Then the functionality reverts to a standby master server. In response to the active master server and the first standby master server becoming unavailable, the second standby master server is used. During an operation on the standby server, a bug occurs in Kubernetes. For example, in response to running a particular command in Kubernetes on a master server causes the active and standby master servers to fail. The bug is a sporadic bug, wherein the failure occurs sometimes, but does not occur all of the time. In response to the master servers going down, the cluster goes down. The command is identified in Bug Repository 250 as a critical issue and as a sporadic bug. A precautionary step is added to the MOPs in the MOP Repository 270 so that in response to execution of this particular command, a notice is generated to check the health of the master server or to check the status of the service (e.g., a service that is killed on the master server).

The operation of MOPs in MOP Repository 270 is based upon the result of additional verification, precautionary steps, or operations that are planned during a maintenance window because of identification of an impact based on identification of a match between MOPS in MOP Repository 270 and bug details in Bug Repository 250. The user is able to quickly check the commands, if any, that are impacted due to the open or known bugs. The user determines whether the open or known bugs affects MOPS in the MOP Repository 270.

Without Bug Repository 250, the user relies on MOP repository and an examination of the OSS websites for open or known bugs based on a keyword search, and the user is able to easily miss an applicable bug, and operators find the process to be tedious and time consuming. Software problems are especially problematic in case of corner or sporadic problems. A corner case involves a problem that occurs outside of specified operating parameters, specifically when multiple environmental variables or conditions occur simultaneously at extreme levels, even though a parameter is within the specified range for that parameter. For example when computer is put on load with a process using a recommended amount of RAM of CPU load for longer times in a session, a system begins to slow down. Neither validation of MOPs nor laboratory testing is efficient or sufficient to address the impact of known or open software bugs, and especially corner or sporadic bugs, on operations and change requests (CR). To address these problems, MOP Risk Assessment Dashboard 280 accesses Bug Repository 250 and MOP Repository 270, and AI/ML Framework 284 matches existing MOP IDs 271 with bugs in Bug Repository 250 to identify bugs that impact operation of the OSS. Repetitive researching and monitoring the Open-Source Software communities is performed to maintain and update Bug Repository 250, e.g., blogs and associated websites.

AI/ML Framework 284 performs risk assessment and presents a report on MOP Risk Assessment Dashboard 280 with mapped MOP IDs 271 and Bug IDs 251. AI/ML Framework 284 identifies existing MOP IDs 271 that are impacted by which Bug IDs 251, identifies the impacted commands 254, the affected servers 256, the affected OS 257, etc.

In response to a new MOP being added to MOP Repository 270 or a bug being added to Bug Repository 250, the impact is observable in real time. Bug IDs 251 that impact a new MOP ID 271 are easily identifiable. Thus, System 200 is able to be used dynamically, or statically.

System 20 does not rely on specific hardware or software. System 200 relies on a database where the information about bugs stored in the Bug Repository 250 and the procedures listed in MOP Repository 270 are stored.

The AI/ML Framework 284 is able to be based on scripts or other logic. Again a specific server or system is not used. System 200 is applicable to general systems using virtualization based on OSS software or commodity hardware utilization, such as e-commerce or Internet related systems, and to more specific implementations, such as open software or commodity hardware utilization used in the telecommunications industry.

System 200 including Bug Repository 250, MOP Repository 270, MOP Risk Assessment Dashboard 280, and AI/ML Framework 284 provide the advantages of providing automatic impact assessment of known bugs on operation and change requests (CR). A MOP Risk Assessment Dashboard 280 using an AI/ML Framework 284 is able to perform a quick check of operation of OSS against known bugs based on information from Bug Repository 250 and MOP Repository 270.

MOP Risk Assessment Dashboard 280 performs real time impact assessment by using AI/ML Framework 284 to match Bug IDs 251 in Bug Repository 250 and MOP IDs 271 in MOP Repository 270 to minimize the impact and down time. The impact assessment process is simplified and speeds the process of impact assessment of known bugs on operation and change requests (CR). The MOP Risk Assessment Dashboard 280 uses the AI/ML Framework 284 to provide automatic impact assessment of known bugs on operations and change requests (CR), provide a higher operation success rate, reduce cost of verification and troubleshooting, and reduce employee stress during operations by making of operations safe, repeatable, and stress free. The user is able to quickly check the commands, if any, that are impacted due to the open or known bugs.

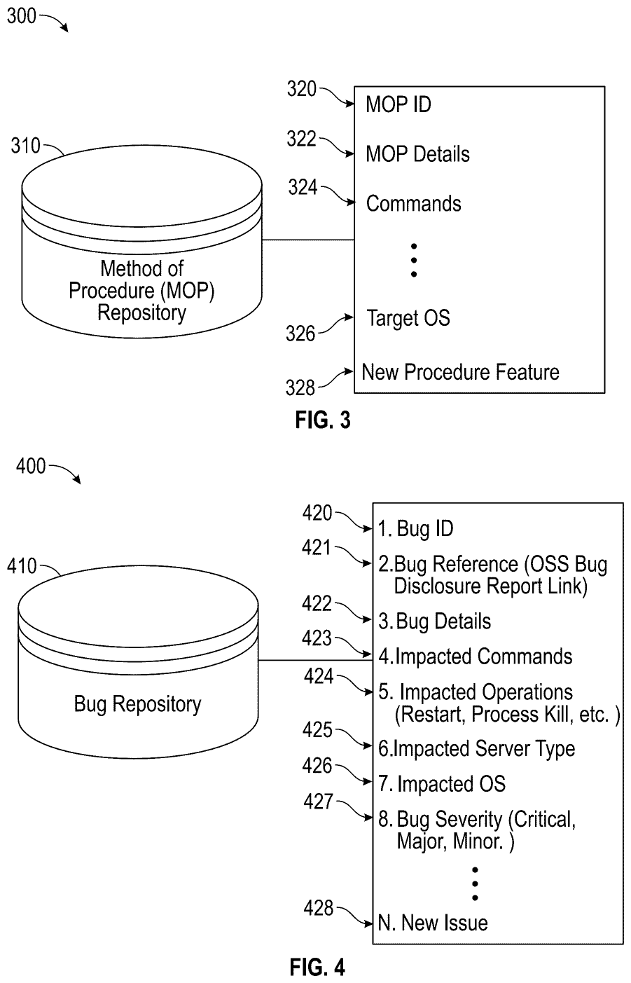

FIG. 3 is a diagram of a Method of Procedure (MOP) Repository 300 according to at least one embodiment.

In FIG. 3, a storage device 310 is used to maintain the MOP Repository 300. MOP Repository 300 provides precise step-by-step information for providing automatic impact assessment of open/know bugs on operations and change requests (CR) according to at least one embodiment. MOP Repository 300 provides a means to control the outcome of the automatic impact assessment and reduces problems that may arise from guesswork or human error. MOP Repository 300 provides uniformity and accuracy while avoiding (or at least minimizing) mistakes.

MOP Repository 300 includes, at least, MOP ID 320, MOP Details 322, Commands 324, and Target OS 326. MOP Repository 300 is able to be supplemented to add New Procedure Features 328. For example, MOP Repository 300 is able to be modified to include New Procedure Features 328, such as Target Servers or other additional features.

FIG. 4 is a diagram of a Bug Repository 400 according to at least one embodiment.

In FIG. 4, a storage devices 410 is used to maintain the Bug Repository 400. Known or open bugs are identified by members of the OSS community. A team monitors community sources associated with the particular OSS that list known/open bugs. The team includes Subject Matter Exerts (SME) and members of a Tactical Assistance Committed (TAC) that populate the Bug Repository 400.

Bug Repository 400 includes information associated with bugs, such as Bug Identifier (ID) 420, Bug Reference (OSS bug disclosure/report link) 421, Bug details 422, Impacted Commands 423, Impacted Operations (restart, process kill etc.) 424, Impacted Server Type 425, Impacted Operating System (OS) 426, and Bug Severity (e.g., Critical, Major, Minor) 427. Bug Repository 400 is also able to be supplemented to add New Issues 428.

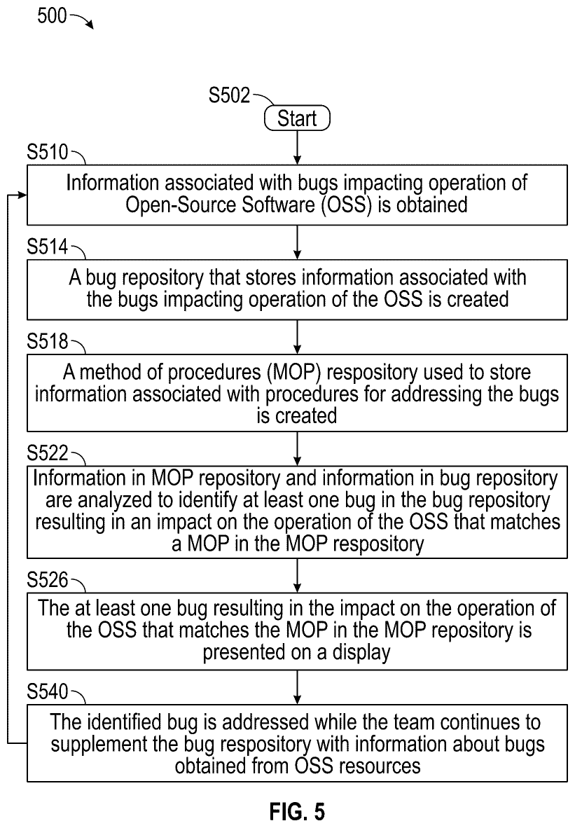

FIG. 5 is a flowchart 500 of a method for merging regions according to at least one embodiment.

In FIG. 5, the method starts S502 and information associated with problems impacting operation of the OSS is obtained S510. Referring to FIG. 2, a Team 230 monitors the OSS Resources 210 that are associated with OSS of interest. The Team 230 obtains information about bugs 220 from the OSS Resources 210. The Team 230 includes Subject Matter Experts (SME) and members of a Tactical Assistance Committee (TAC). To obtain information about known or open bugs of OSS of interest, Team 230 studies the OSS resources 210 and identifies bugs that are capable of having an impact on operations or change requests (CR). The SME and TAC Team 230 reviews the OSS resources 210 and studies open bugs 231, monitors community discussions related to performance, stability, security, and vulnerability of OSS 232, determines the impacts of identified bugs 233, retrieves OSS contributions to the identification of bugs 234, and creates a detailed report and explanation associated with the known/open bugs 235. The report 235 is accessible for internal use in determining the impact of known/open bugs. Additional or alternative information 236 is able to be obtained by the SME and TAC Team 230.

A bug repository for storing information associated with the bugs is created S514. Referring to FIG. 2, SME and TAC Team 230 provides the obtained bug information 240 to Bug Repository 250. Bug Repository 250 includes information associated with bugs, such as Bug Identifier (ID) 251, Bug Reference (OSS disclosure/report link) 252, Bug details 253, Impacted Commands 254, Impacted Operations 255 (restart, process kill etc.), Impacted Server Type 256, Impacted Operating System (OS) 257, and Bug Severity 258 (e.g., Critical, Major, Minor). Bug Repository 250 is also able to be supplemented to add New Issues 259. Depending upon the research that is performed by the SME and TAC Team 230, Bug Repository 250 keeps evolving.

A method of procedures (MOP) repository for storing procedures for addressing the bugs is created S518. Referring to FIG. 2, MOP Repository 270 is created by mitigation teams to provide precise step-by-step information for providing procedures for addressing open/known bugs of OSS to provide automatic impact assessment of the bugs on operations and change requests (CR) according to at least one embodiment. A change request is a proposal made in the software development process to change an aspect or coding in the OSS. An example of a change requests include requests to correct defects or bugs. In at least one embodiment, the MOP Repository 270 is based on an operations manual. MOP Repository 270 provides a means to control the outcome of the automatic impact assessment and reduces problems that may arise from guesswork or human error. MOP Repository 270 is able to provide uniformity and accuracy while avoiding (or at least minimizing) mistakes. MOP Repository 270 includes a MOP ID 271, MOP Details 272, a list of Commands 273, Target OS 274, etc. MOP Repository 270 is able to be supplemented to add New Procedure Features 275. For example, MOP Repository 270 is able to identify what type of server, OS version, etc. that is impacted by bugs. A validation of MOPS Repository 270 is performed and the details are listed in the MOP repository 270.

Information in MOP repository and information in bug repository are analyzed to identify at least one bug in the bug repository resulting in an impact on the operation of the OSS that matches a MOP in the MOP repository S522. Referring to FIG. 2, MOP Risk Assessment Dashboard 280 is shown to include AI/ML Framework 284. AI/ML Framework 284 receives information 292 from Bug Repository 250. AI/ML Framework 284 also receives information 294 from MOP Repository 270. Based on that selection or filtering of bugs, the AI/ML Framework 284 compares the bugs in Bug Repository 250 applicable to the OSS to MOPS in the MOPS Repository 270. The AI/ML Framework 284 is based upon matching logic that improves over time. Initially, before the AI/ML Framework 284 has been trained, tested, and validated, System 200 is not automated. However, Bug Repository 250 and MOP Repository 270 enable impact assessment based on manual comparisons. Thus, initially a manual confirmation of MOPs in MOP Repository 270 is performed. In at least one embodiment, a manual comparison involves performing a check of critical bugs in Bug Repository 250 against MOPs in MOP Repository 270. Bug Repository 250 and MOP Repository 270 are used to provide an impact assessment that enables secure operations after a manual check. Once the AI/ML Framework 284 is able to take over, the AI/ML Framework 284 provides automatic impact assessment of known bugs on operations and change requests (CR). AI/ML Framework 284 identifies existing MOP IDs 271 that are impacted by which Bug IDs 251, identifies the impacted commands 254, the affected servers 256, the affected OS 257, etc.

The at least one bug resulting in the impact on the operation of the OSS that matches the MOP in the MOP repository is presented on a display S526. Referring to FIG. 2, based upon a match being identified, Bug ID's 251 are listed against MOP IDS 271 that reflect risk. The risks are based upon Bug Severity 258. AI/ML Framework 284 performs risk assessment and presents a report on MOP Risk Assessment Dashboard 280 with mapped MOP IDs 271 and Bug IDs 251.

The identified bug is addressed while the team continues to supplement the bug repository with information about bugs obtained from OSS resources S540.

At least one embodiment, a method for performing automatic impact assessment on operations and change requests (CR) caused by bugs of Open-Source Software (OSS) includes creating a bug repository for storing information about bugs of OSS, creating a method of procedures (MOP) repository for storing procedures for addressing the bugs of the OSS, analyzing the procedures in the MOP repository for addressing the bugs and information about the bugs in the bug repository to identify at least one bug resulting in an impact on the operation of the OSS, and presenting, on a display, the at least one bug resulting in the impact on the operation of the OSS.

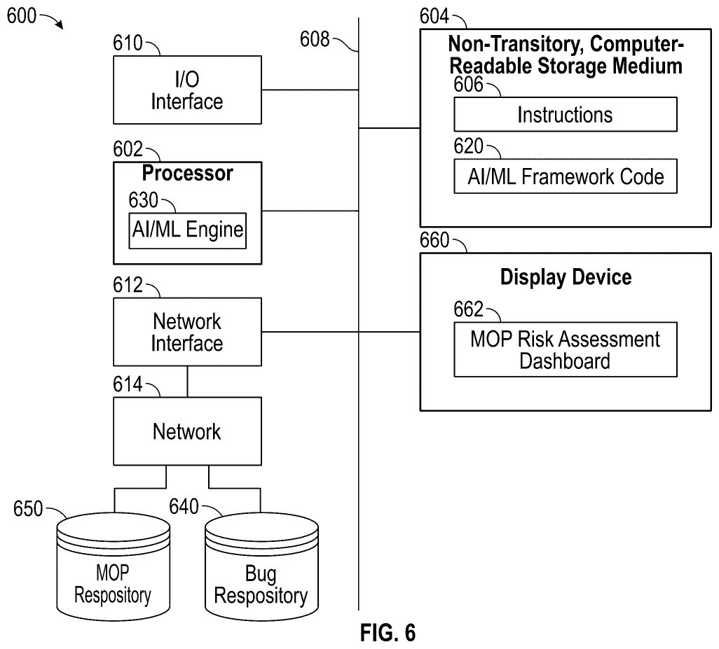

FIG. 6 is a high-level functional block diagram of a processor-based system 600 according to at least one embodiment.

In at least one embodiment, processing circuitry 600 performs automatic impact assessment on operations and change requests (CR) caused by bugs of Open-Source Software (OSS). Processing circuitry 600 implements a method for performing automatic impact assessment on operations and change requests (CR) caused by bugs of OSS using processor 602. Processing circuitry 500 also includes a non-transitory, computer-readable storage medium 604 that is used to perform automatic impact assessment on operations and change requests (CR) caused by bugs of OSS.

Storage medium 604, amongst other things, is encoded with, i.e., stores, instructions 606, i.e., computer program code that are executed by processor 602 causes processor 602 to perform automatic impact assessment on operations and change requests (CR) caused by bugs of OSS. Execution of instructions 606 by processor 602 represents (at least in part) an application which implements at least a portion of the methods described herein in accordance with one or more embodiments (hereinafter, the noted processes and/or methods).

Processor 602 is electrically coupled to computer-readable storage medium 604 via a bus 608. Processor 602 is electrically coupled to an Input/output (I/O) interface 610 by bus 608. A network interface 612 is also electrically connected to processor 602 via bus 608.

Network interface 612 is connected to a network 614, so that processor 602 and computer-readable storage medium 604 connect to external elements via network 614. Processor 602 is configured to execute instructions 606 encoded in computer-readable storage medium 604 to cause processing circuitry 600 to be usable for performing at least a portion of the processes and/or methods. In one or more embodiments, processor 602 is a Central Processing Unit (CPU), a multi-processor, a distributed processing system, an Application Specific Integrated Circuit (ASIC), and/or a suitable processing unit.

Processing circuitry 600 includes I/O interface 610. I/O interface 610 is coupled to external circuitry. In one or more embodiments, I/O interface 610 includes a keyboard, keypad, mouse, trackball, trackpad, touchscreen, and/or cursor direction keys for communicating information and commands to processor 602.

Processing circuitry 600 also includes network interface 612 coupled to processor 602. Network interface 612 allows processing circuitry 600 to communicate with network 614, to which one or more other computer systems are connected. Network interface 612 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 600 is configured to receive information through I/O interface 610. The information received through I/O interface 610 includes one or more of instructions, data, design rules, libraries of cells, and/or other parameters for processing by processor 602. The information is transferred to processor 602 via bus 608. Processing circuitry 600 is configured to receive information related to a User Interface (UI) through I/O interface 610. The information is stored in computer-readable medium 604.

In one or more embodiments, one or more non-transitory computer-readable storage media 604 having stored thereon instructions (in compressed or uncompressed form) that may be used to program a computer, processor, or other electronic device) to perform processes or methods described herein. The one or more non-transitory computer-readable storage media 604 include one or more of an electronic storage medium, a magnetic storage medium, an optical storage medium, a quantum storage medium, or the like.

For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 604 includes a Compact Disk-Read Only Memory (CD-ROM), a Compact Disk-Read/Write (CD-R/W), and/or a Digital Video Disc (DVD).

In one or more embodiments, storage medium 604 stores computer program code/instructions 606 configured to cause processing circuitry 600 to perform at least a portion of the processes and/or methods for providing automatic impact assessment of known bugs on operations and change requests (CR). In one or more embodiments, storage medium 604 also stores information, such as algorithm which facilitates performing at least a portion of the processes and/or methods for providing automatic impact assessment of known bugs on operations and change requests (CR).

Storage medium 604 includes AI/ML Framework Code 620 that is executed by Processor 602 to implement AI/ML Engine 630. Processor 602 uses AI/ML Engine 630 to process information from MOP repository and bug repository via Network Interface 612 and Network 614 to compare the bugs in Bug Repository 640 applicable to the OSS to MOPs in the MOP repository 650. The AI/ML Engine 630 uses logic that improves over time to identify bugs in bug repository that match MOPs in MOP repository. Initially, before the AI/ML Engine 630 has been trained, tested, and validated, Processing circuitry 600 is not automated. However, Bug Repository 640 and MOP Repository 650 enable impact assessment based on manual comparisons. Thus, initially a manual confirmation of MOPs in MOP Repository 650 is performed.

In at least one embodiment, a manual comparison involves performing a check of bugs in Bug Repository 640 against MOPs in MOP Repository 650. Bug Repository 640 and MOP Repository 650 are used to provide an impact assessment that enables secure operations after a manual check using MOP Risk Assessment Dashboard 662 presented on Display Device 660. Once AI/ML Engine 630 is able to take over, the AI/ML Engine 630 provides automatic impact assessment of known bugs on operations and change requests (CR). AI/ML Engine 630 identifies existing MOP IDs in MOP Repository 650 that are impacted by which Bug IDs in Bug Repository 640, identifies impacted commands, affected servers, affected OS 257, etc.

Accordingly, in at least one embodiment, the Processor 602 enables a user to perform a method for automatic impact assessment of known bugs on operations and change requests (CR). The method is able to be performed automatically by AI/ML Engine 630 or through the use of MOP Risk Assessment Dashboard 662 presented on Display Device 660. The method for performing automatic impact assessment of known bugs on operations and change requests (CR) includes creating a bug repository for storing information about bugs of OSS, creating a method of procedures (MOP) repository for storing procedures for addressing the bugs of the OSS, analyzing the procedures in the MOP repository for addressing the bugs and information about the bugs of the bug repository to identify at least one bug resulting in an impact on the operation of the OSS, and presenting, on a display, the at least one bug resulting in the impact on the operation of the OSS.

The method for performing automatic impact assessment of known bugs on operations and change requests (CR) includes at least the advantages of providing automatic impact assessment of known bugs on operation and change requests (CR). A MOP Risk Assessment Dashboard using an AI/ML engine to perform a quick check of operation safety against known bugs based on information form a bug repository and a MOP repository. MOP Risk Assessment Dashboard performs real time impact assessment by matching bug IDs and MOP IDs to minimize the impact and down time. The impact assessment process is simplified and speeds the process of impact assessment of known bugs on operation and change requests (CR).

The MOP Risk Assessment Dashboard uses the AI/ML engine to provide automatic impact assessment of known bugs on operation and change requests (CR), provide a higher operation success rate, reduce cost of verification and troubleshooting, and reduce employee stress during operations by making of operations safe, repeatable, and stress free. The user is able to quickly check the commands, if any, that are impacted due to the open or known bugs. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for performing automatic impact assessment on operations and change requests (CR) caused by bugs of open-source software (OSS), comprising:
creating a bug repository for storing information about bugs of OSS;
creating a method of procedures (MOP) repository for storing procedures for addressing the bugs of the OSS;
analyzing the procedures in the MOP repository for addressing the bugs and information about the bugs in the bug repository to identify at least one bug resulting in an impact on the operation of the OSS; and
presenting, on a display, the at least one bug resulting in the impact on the operation of the OSS.

2. The method of claim 1, wherein the presenting, on the display, the at least one bug resulting in the impact on the operation of the OSS includes presenting the at least one bug on a MOP risk assessment dashboard.

3. The method of claim 2, wherein the identifying the at least one bug resulting in the impact on the operation of the OSS includes manually comparing the information about the bugs in the bug repository to the procedures in the MOP repository on the MOP risk assessment dashboard to identify a match between the bugs in the bug repository and the procedures in the MOP repository.

4. The method of claim 1, wherein the analyzing is performed using artificial intelligence to identify a match between the bugs in the bug repository and the procedures in the MOP repository.

5. The method of claim 1, wherein the creating the bug repository for storing information associated with bugs of OSS includes obtaining information about bugs from one or more OSS resources and providing the information about the bugs to the bug repository.

6. The method of claim 5, wherein the obtaining information about the bugs from the one or more OSS resources includes obtaining bug data based on a study of open bugs identified in the OSS resources, determining the impact of the bugs identified in the OSS resources, creating a detailed report and explanation about the bugs identified in the OSS.

7. The method of claim 1, wherein the creating the bug repository for storing the information about the bugs of the OSS includes storing at least one of identifiers of the bugs, bug references to an OSS bug disclosure report, details about the bugs, commands impacted by the bugs, operations impacted by the bugs, servers impacted by the bugs, operation systems impacted by the bugs, or a bug severity associated with the bugs.

8. A system for performing automatic impact assessment of bugs of open-source software (OSS), comprising:
a memory storing computer-readable instructions; and
a processor connected to the memory, wherein the processor is configured to execute the computer-readable instructions to:
create a bug repository storing information about bugs of OSS;
create a method of procedures (MOP) repository for storing procedures for addressing the bugs of the OSS;
analyze the procedures in the MOP repository for addressing the bugs and information about the bugs in the bug repository to identify at least one bug resulting in an impact on operation of the OSS; and
present, on a display, the at least one bug resulting in the impact on the operation of the OSS.

9. The system of claim 8, wherein the processor is further configured to present, on the display, the at least one bug resulting in the impact on the operation of the OSS by presenting the at least one bug on a MOP risk assessment dashboard.

10. The system of claim 9, wherein the processor is further configured to identify the at least one bug resulting in the impact on the operation of the OSS by presenting, on the MOP risk assessment dashboard, the information about the bugs in the bug repository and the procedures in the MOP repository for manual comparison for identifying a match between the bugs in the bug repository and the procedures in the MOP repository.

11. The system of claim 8, wherein the processor is further configured to use artificial intelligence to analyze the procedures in the MOP repository for addressing the bugs and the information about the bugs in the bug repository to identify the at least one bug resulting in the impact on the operation of the OSS.

12. The system of claim 8, wherein the processor is further configured to create the bug repository for storing the information associated with the bugs of the OSS by obtaining the information about the bugs from one or more OSS resources and providing the information about the bugs to the bug repository.

13. The system of claim 12, wherein the processor is further configured to obtain the information about the bugs from one or more OSS resources by obtaining the information about the bugs based on bug data derived from a study of open bugs identified in the OSS resources, determining the impact of the bugs identified in the OSS resources, creating a detailed report and explanation about the bugs identified in the OSS.

14. The system of claim 8, wherein the processor is further configured to create the bug repository for storing information about the bugs of the OSS by storing identifiers of the bugs, bug references to an OSS bug disclosure report, details about the bugs, commands impacted by the bugs, operations impacted by the bugs, servers impacted by the bugs, operation systems impacted by the bugs, and a bug severity associated with the bugs.

15. A non-transitory computer-readable media having computer-readable instructions stored thereon, which when executed by a processor causes the processor to perform operations comprising:
creating a bug repository for storing information about bugs of OSS;
creating a method of procedures (MOP) repository for storing procedures for addressing the bugs of the OSS;
analyzing the procedures in the MOP repository for addressing the bugs and information about the bugs in the bug repository to identify at least one bug resulting in an impact on the operation of the OSS; and
presenting, on a display, the at least one bug resulting in the impact on the operation of the OSS.

16. The non-transitory computer-readable media of claim 15, wherein the presenting, on the display, the at least one bug resulting in the impact on the operation of the OSS includes presenting the at least one bug on a MOP risk assessment dashboard.

17. The non-transitory computer-readable media of claim 16, wherein the identifying the at least one bug resulting in the impact on the operation of the OSS includes manually comparing the information about the bugs in the bug repository to the procedures in the MOP repository on the MOP risk assessment dashboard to identify a match between the bugs in the bug repository and the procedures in the MOP repository.

18. The non-transitory computer-readable media of claim 15, wherein the analyzing is performed using artificial intelligence to identify a match between the bugs in the bug repository and the procedures in the MOP repository.

19. The non-transitory computer-readable media of claim 15, wherein the creating the bug repository for storing information associated with bugs of OSS includes obtaining information about bugs from one or more OSS resources and providing the information about the bugs to the bug repository, and wherein the obtaining the information about the bugs from the one or more OSS resources includes obtaining bug data based on a study of open bugs identified in the OSS resources, determining the impact of the bugs identified in the OSS resources, creating a detailed report and explanation about the bugs identified in the OSS.

20. The non-transitory computer-readable media of claim 15, wherein the creating the bug repository for storing the information about the bugs of the OSS includes storing at least one of identifiers of the bugs, bug references to an OSS bug disclosure report, details about the bugs, commands impacted by the bugs, operations impacted by the bugs, servers impacted by the bugs, operation systems impacted by the bugs, or a bug severity associated with the bugs.
